(19) United States
(12) Patent Application Publication
(10) Pub. No.: US 2019/0090050 A1
(43) Pub. Date: Mar. 21, 2019

(54) EXTRACTING BACK VOLUME FOR SPEAKERS IN THIN UNIBODY DEVICES

(71) Applicant: Intel Corporation, Santa Clara, CA (US)

(72) Inventors: RAJEEV REMA SHANMUGAM, Bangalore (IN); PRAKASH KURMA RAJU, Bangalore (IN); GOPINATH K., Bangalore (IN)

(21) Appl. No.: 15/706,494

(22) Filed: Sep. 15, 2017

(51) Int. Cl. H04R 1/34; H04R 1/02; H04R 1/28

(52) U.S. Cl. CPC H04R 1/345; H04R 1/025; H04R 1/028; H04R 2499/15; H04R 2201/029; H04R 2499/11; H04R 1/2826

(57) ABSTRACT

Related fields include portable device assemblies, and in particular, techniques to extract back volume for speakers in thin unibody devices. A system consistent with the present disclosure comprises a unibody structure to support internal components of an electronics device. The unibody structure has a thickness of less than 7 mm. The chamber region is to facilitate a back volume of at least 0.77 cubic centimeters. The system further included a speaker that is fitted within a speaker cavity.

### FIELD

Related fields include portable device assemblies, and in particular, techniques to extract back volume for speakers in thin unibody devices.

### BACKGROUND

Recently, consumer electronics have become thinner and incorporate unibody structures. This trend has posed a challenge for placing speakers within consumer devices and providing the necessary back volume for maximum audio performance. Conventional assembly techniques are often incapable of providing the necessary back volume for consumer electronics with speaker devices therein. The present disclosure addresses this need.

### BRIEF DESCRIPTION OF DRAWINGS

To facilitate understanding, identical reference numerals have been used, where possible, to designate identical elements that are common to the drawings. The present disclosure may readily be understood by considering the following detailed description with the accompanying drawings which are not necessarily drawn to scale, in which:

FIG. 1 illustrates a cover or casing to provide sufficient back volume for a speaker component of an electronics device.

FIG. 2 illustrates a cover or casing having a second set of dimensions to provide sufficient back volume for a speaker component of an electronics device.

FIGS. 3A-3B illustrate cross-sectional and perspective views of a cover or casing which provides sufficient back volume for a speaker component of an electronics device.

### DETAILED DESCRIPTION

The description of the different advantageous embodiments has been presented for purposes of illustration, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

In this document, the following terms will have the following definitions:

Gas AssistMolding: A technique used in injection molding techniques to create hollow plastic objects without openings. Gas assist molding may be used to create concealed chambers within plastic parts by passing pressurized inert gas through the molten plastic during injection molding. The passage and pressure are controlled by the tool core and cavity. By passing the inert gas through the molten plastic, the hollow structure is created within the plastic part. Steering wheels, handles, etc. may be manufactured by this process.

Along with substantial reduction of material cost, additional savings are achieved through use of the gas assist process. Since it requires typically a fraction (e.g, one-third) of the clamping forces of conventional injection molding, this process can be performed more economically on smaller presses and with faster cycle times. Reduced in-mold pressure also allows the use of less expensive steel or aluminum tooling while subjecting it to less wear-and-tear. Parts also weigh considerably less which results in reduced freight expense and improved material handling efficiencies.

Gas assist molding technology offers many design and performance advantages over other large part molding processes. Long shapes and multiple parts with complex designs and differing wall thickness can be molded as a single part and with tighter tolerances. In addition, parts exhibit improved dimensional stability, better quality surfaces, and require minimal or no secondary operations.

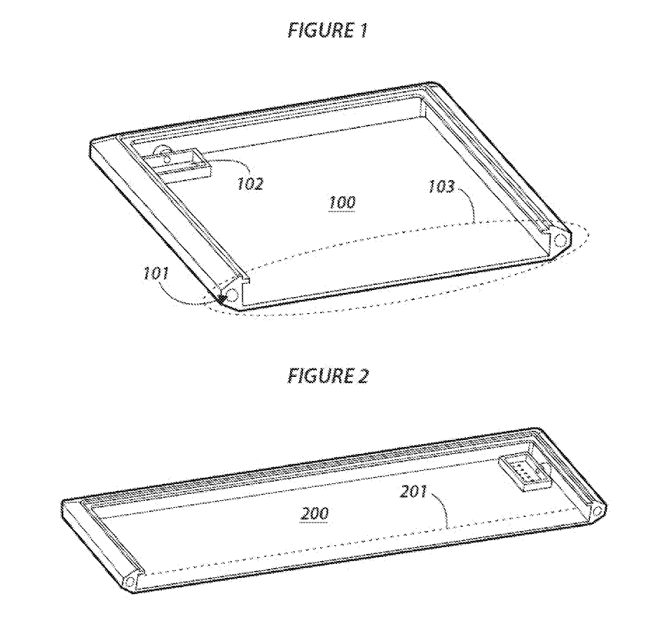

FIG. 1 illustrates a cover or casing 100, which provides sufficient back volume for a speaker component of an electronics device. Casing 100 may be incorporated within a laptop device, 2:1 device, notebook, table, or mobile phone (e.g., smartphone). In some embodiments, casing 100 is utilized as a rear cover for a mobile phone.

Casing 100 is formed by a gas assist molding technique with thin dimensions. Casing 100 may include a unibody structure that has a cross-sectional thickness that is less than 7 mm. In one or more embodiments, the cross-sectional thickness of casing 100 is approximately 6.5 mm. Advantageously, gas assist molding may eliminate process steps to fabricate casing 100.

In some implementations, casing 100 consists of a unibody structure that is formed from a single molding according to some embodiments. As such, the gas assist molding technique not only provides a relatively thin structure but also provides a uniform structure that does not suffer from warpage and leakage problems that are characteristic of devices that are manufactured by other methods.

Casing 100 includes an undercut region 103 that has a chamber region 101. Chamber region 101 is to facilitate a back volume to provide sufficient sound projection from a speaker. One having ordinary skill in the art may appreciate that back volume is essential to project sound from speakers as air within the enclosed volume pushes against the speaker which aids in the sound projection and to achieve better bass performance.

For example, chamber region 101 may facilitate a back volume of at least 0.77 cubic centimeters. In some embodiments, chamber region facilitates a back volume of approximately 1.0 cubic centimeters.

Chamber region 101 may be fashioned to have any suitable set of dimensions to facilitate sufficient back volume. For example, chamber region 101 has a diameter of approximately 4 mm and a length of approximately 100 mm.

Casing 100 also features a speaker cavity 102 in which a speaker may be fitted within. On a peripheral portion of the speaker cavity 102 may be a plurality of vent openings (not shown). In some implementations, the plurality of vent openings may be adjacent to the speaker cavity.

FIG. 2 illustrates a cover or casing 200 having a second set of dimensions, which provides sufficient back volume for a speaker component of an electronics device. Notably, the length 201 of casing 200 may be greater than the length of the casing 100 depicted in FIG. 1. Casing 200 may comprise a plastic housing but the present disclosure is not limited thereto. Casing 200 may include any other suitable material that may be fabricated by a gas assist molding process.

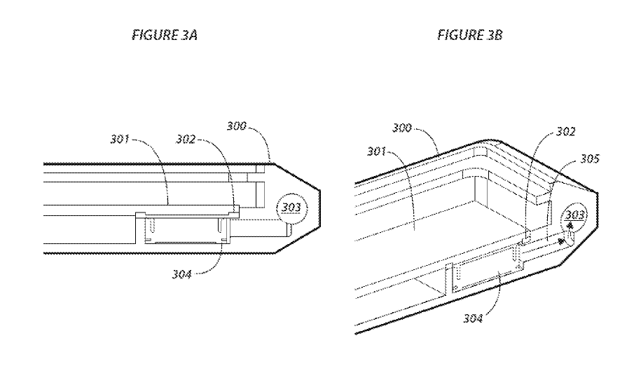

FIGS. 3A-3B illustrate cross-sectional (FIG. 3A) and perspective (FIG. 3B) views of a cover or casing 300 which provides sufficient back volume for a speaker component 304 of an electronics device.

FIG. 3A depicts shows how casing 300 accommodates a plurality of electronic components. For example, within casing 300 is a printed circuit board (PCB) 301, sealing sponge 302, and speaker 303. It should be understood by one having ordinary skill in the art that more or less electronic components may be accommodated by the unibody structure of the casing 300. In addition, casing 300 comprises a chamber 303 to facilitate a back volume for speaker 304.

FIG. 3B provides a perspective view of a portion of the casing 300. In addition, FIG. 3B depicts a back volume path 305. The back volume path 305 can be generated all around the device particularly when there is a restriction in thickness in the device to place a speaker box assembly.

The preceding Description and accompanying Drawings describe examples of embodiments in some detail to aid understanding. However, the scope of protection may also include equivalents, permutations, and combinations that are not explicitly described herein. Only the claims appended here (along with those of parent, child, or divisional patents, if any) define the limits of the protected intellectual-property rights.

What is claimed is:

1. An assembly, comprising:
a unibody structure, comprising:
an undercut section comprising a chamber region,
wherein the chamber region is to facilitate a back volume of one cubic centimeter;
and a speaker cavity.

2. The assembly of claim 1 further comprising a speaker fitted within the speaker cavity.

3. The assembly of claim 1 further comprising a printed circuit board and at least one sealing sponge.

4. The assembly of claim 1, wherein the unibody structure comprises a plastic housing.

5. The assembly of claim 1, wherein the chamber region has a diameter of approximately 4 mm.

6. The assembly of claim 1, wherein the chamber region has a length of approximately 100 mm.

7. The assembly of claim 1, wherein the unibody structure is manufactured by a gas assist molding process.

8. The assembly of claim 1, wherein the unibody structure has a thickness of less than 7 mm.

9. The assembly of claim 1, wherein the unibody structure is at least one of a casing or cover.

10. A system, comprising:
a unibody structure to support internal components of an electronics device;
wherein the unibody structure has a thickness of less than 7 mm;
wherein the chamber region is to facilitate a back volume of at least 0.77 cubic centimeters; and a speaker fitted within a speaker cavity.

11. The system of claim 10, wherein the chamber region is to facilitate a back volume of at least one cubic centimeters.

12. The system of claim 10 further comprising a plurality of vent openings adjacent to the speaker cavity.

13. The system of claim 10, wherein the chamber region has a diameter of approximately 4 mm and a length of approximately 100 mm.

14. The system of claim 10, wherein the unibody structure has a cross-section of approximately 6.5 mm.

15. The system of claim 10, wherein the system includes at least one of a laptop device, 2:1 device, tablet, notebook, or mobile phone.

16. The system of claim 10, wherein the chamber is to facilitate a path for a back volume for the speaker.

17. The system of claim 10, wherein the unibody structure is manufactured by a gas assist molding process.

18. The system of claim 10 further comprising at least one of a display, printed circuit board, or cabling adjacent to the unibody structure.

19. The system of claim 10, wherein the unibody structure is at least one of a casing or cover.

20. The system of claim 19, wherein the unibody structure is a rear cover of a mobile device.
